(19) United States
(12) Patent Application Publication
(10) Pub. No.: US 2010/0219005 A1
(43) Pub. Date: Sep. 2, 2010

(54) Suspension for a telepresence robot

(76) Inventor: Roy Benjamin Sandberg, San Francisco, CA (US)

Correspondence Address: Roy Benjamin Sandberg, 1822 McAllister St. #7, San Francisco, CA, 94115, US

(21) Appl. No.: 12/308,295

(22) PCT Filed: Jun. 11, 2007
(86) PCT No.: PCT/US2007/013697

§ 371 Date: Dec. 11, 2008

(30) Foreign Application Priority Data
Jun. 16, 2006 (US) 60814132

(51) Int. Cl. B62D 61/00

(52) U.S. Cl. 180/21

(57) ABSTRACT

A differential drive suspension for a robot with a high height to weight ratio

### BACKGROUND OF THE INVENTION

(1) Field of Invention

The present invention is related to the field of remote presence, more specifically, the invention is suspension system for use with a mobile remote presence robot.

(2) Related Art

Remote presence robots use a variety of wheel configurations, including Ackerman steering geometries and holonomic platforms. Differential drive robots are a popular choice. For example, the Roomba™ vacuuming robot, made by iRobot™ Corporation uses a differential drive system with two casters. By keeping the center-line of the drive wheels at the center of the robot, the Roomba™ can turn in place. One of the casters is spring-loaded, which allows all four wheels to contact the ground even if the ground is not perfectly flat. This keeps the drive wheels in constant contact with the ground, which prevents the robot from substantially deviating from its course. However, this system would not work on a robot with a large height to weight ratio, as it would teeter precariously due to the spring-loaded wheel. In general, due to the large height to weight ratio of anthropomorphic robots, a differential drive system with more than three three ground contact points is difficult to use, as a suspension system is required to keep both drive wheels in contact with the ground, while still providing enough stability to ensure the robot does not bobble or topple during use.

### SUMMARY OF THE INVENTION

The present invention is a new and improved apparatus for implementing a differential drive system suspension on a robot with a high height to weight ratio.

By tying together the movement of both caster wheels and the movement of both differential drive wheels, a robot is able to maintain constant contact between the ground and all four wheels, without teetering. Because the fore-to-aft wheels and the left-to-right wheels are rigidly attached to separate support structures, and those support structures are free to move in only the vertical direction, the robot maintains a substantially constant vertical posture even in the presence of moderate lateral forces. The stability gained by these separare support structures can be compared to the operation of an anti-sway bar element as used in car suspension design, except here the “anti-sway” capability is provided along two substantially orthogonal axes.

The support structures' freedom to travel relative to each other allows the robot to traverse terrain that has surface irregularities without the drive wheels substantially losing contact with the surface. Finally, in the most basic design, only one spring and one hinged assembly is required, simplifying the design of the suspension. In an alternative design, two springs and two hinged assemblies are used, providing improved road holding and stability with a small increase in relative design complexity.

The design is also suitable for other applications where a high height to weight ratio is found and differential drive is used.

### DETAILED DESCRIPTION OF THE DRAWINGS

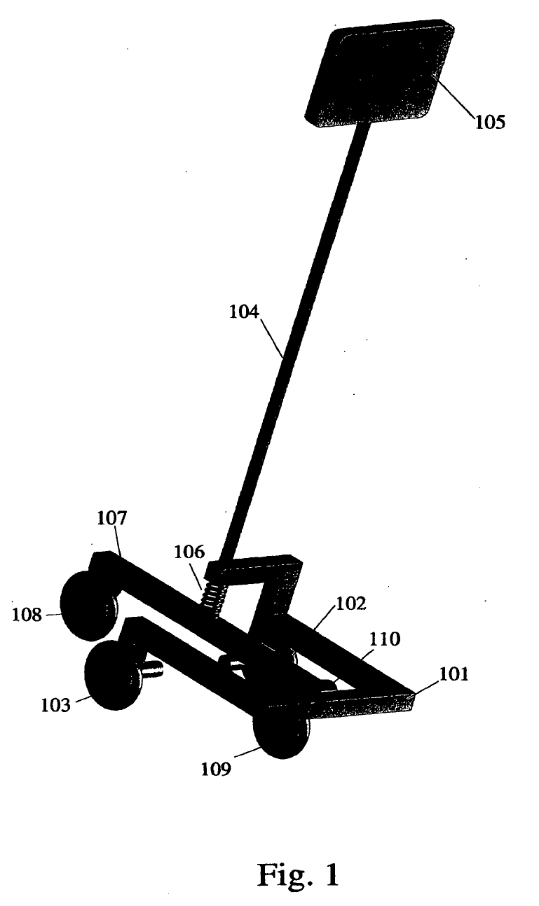

FIG. 1 is a exemplary embodiment of the invention.

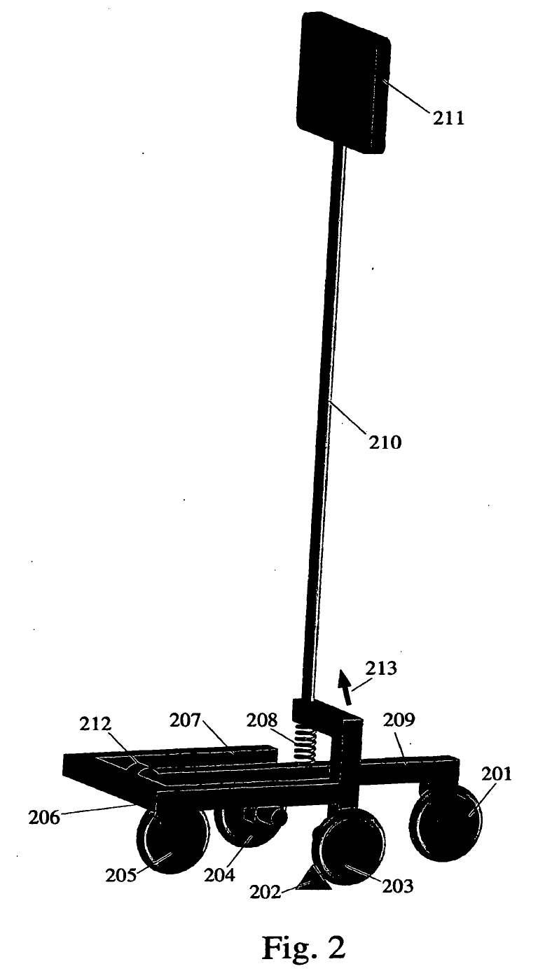

FIG. 2 is a diagram illustrating the device traversing uneven terrain

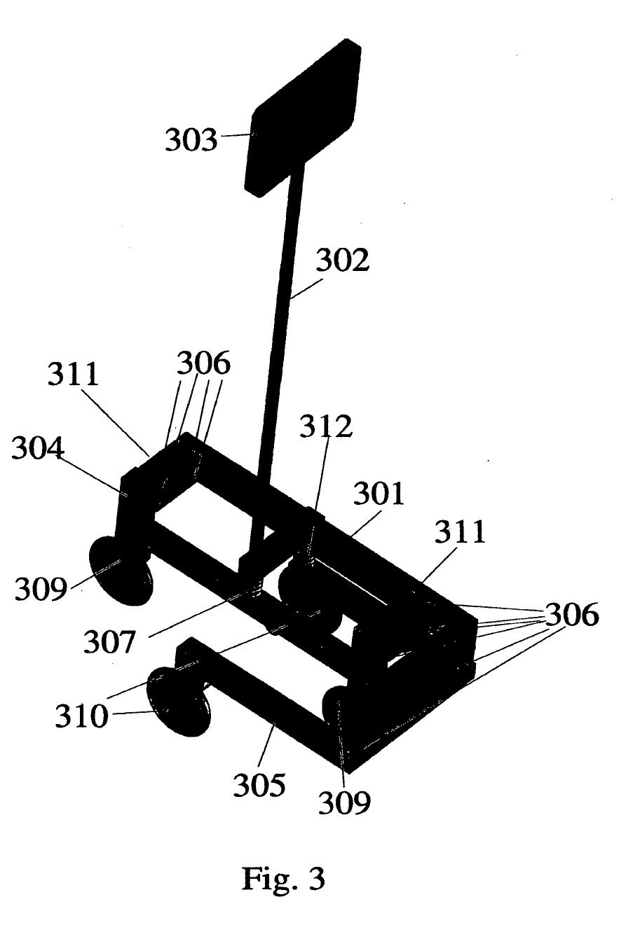

FIG. 3 is an alternative embodiment illustrating the device with two swing-arms.

### DETAILED DESCRIPTION OF THE INVENTION

The present invention is a new and improved apparatus for implementing a differential drive system suspension on a robot with a high height to weight ratio. In the preferred embodiment, the robot has a weight of approximately 30 pounds and a height of approximately 6 feet.

This patent application incorporates by reference copending application Ser. No. 11/223,675. Matter essential to the understanding of the present application is contained therein.

FIG. 1 is an exemplary embodiment of the invention. A rigid chassis 101 supports a vertical stalk 104, which in-turn supports an audio-visual unit 105. In the preferred embodiment, the rigid chassis is made of stamped sheet metal or injection molded plastic, but other substantially rigid materials may also be used. Typically, the rigid chassis will be about thirty to sixty centimeters in length and width. In the preferred embodiment, the vertical stalk is composed of extruded aluminum or plastic tubing, but other substantially rigid materials may also be used. In the preferred embodiment the audio-visual unit is a plastic housing, but other materials may also be used. The rigid chassis also serves as an attachment point for a right motor-drive wheel 102 and a left motor-drive wheel 103. In an alternative embodiment, the right motor drive-wheel 102 and left motor drive-wheel 103 are attached to a second swing-arm assembly, the second swing-arm assembly being rotatably attached to the rigid chassis.

In the preferred embodiment, the right and left motor-drive wheels consist of 125 millimeter hard polyurethane wheels drive by a gear-reduction mechanism, which in turn is driven by an electric motor. Other wheel types and sizes, and other drive mechanisms known in the art may also be used. A first swing arm assembly 107 rotatably connects to the rigid chassis via a hinge mechanism 110. In the preferred embodiment, the first swing arm is made of stamped sheet metal or injection molded plastic, but other substantially rigid materials may also be used. Typically, the first swing arm assembly will be thirty to sixty centimeters in length. Other techniques known in the art to enable rotatable connections, such as rotating couplings, bearings, and rods may be used in lieu of the hinge. The hinge mechanism or equivalent may be composed of any material known to be strong enough to accept the loading forces imposed by the first swing arm and rigid chassis. Typically this would be metal or plastic. The movement of the first swing arm is restrained by a spring 106 that moveably connects the first swing arm to the rigid chassis. In the preferred embodiment, the spring is long enough to minimize spring loading changes during typical travel of the first swing arm. In the preferred embodiment a coiled metal spring is used, but other techniques known to approximate an idealized spring, such as pneumatic cylinders, rubber or other elastic materials, torsion springs, torsion beams, leaf springs, or even the spring constant inherent in the rigid chassis or first swing arm may also be used. Additionally, if the weight on the fore-aft axis and the left-right axis is substantially equal without a spring, then the device can be implemented with no spring at all. In an alternative embodiment, the travel of the first swing arm is limited by one or more travel limits.

A front caster wheel assembly 108 and a rear caster wheel assembly 109 rotatably connect to the first swing arm assembly. In the preferred embodiment, the caster wheels are 125 millimeter polyurethane wheels connected to a sheet metal caster mechanism, but any mechanism capable of low friction travel along a plane, such as omni-wheels or low-friction materials, may also be used. Via vertical motion of the first swing arm assembly, all four wheels are kept substantially in contact with the ground even when traversing small obstacles and ramps.

The maximum size obstacle a wheel can traverse is often approximated as being a third of the diameter of the wheel. Therefore, in the preferred embodiment, the first swing arm will allow the left and right wheels to travel at least 42 millimeters (125/3) above and below the fore and aft wheels. The obstacle can also be a small hole in the ground, where the first swing arm travel distance is designed to accommodate the largest hole depth the system is intended to operate with. Due to the rigid connection of the left and right drive wheels through the rigid chassis, left-to-right oscillations of the device are reduced, despite the high center of gravity created by the vertical stalk and audio-visual unit. Due to the rigid connection of the fore and aft caster wheels through the first swing arm assembly, fore-to-aft oscillations of the device are similarly reduced. In the preferred embodiment of the invention, the force on the spring 106 is selected such that the weight distribution is evenly distributed between all four wheels. Additionally, in the preferred embodiment, the spring length is selected such that typical movements of the first swing arm assembly do not substantially alter this weight distribution. This allows the device to traverse small obstacles and ramps without substantially altering its weight distribution, and hence with substantially constant down force on the drive wheels. This helps make the robot's ground traction more consistent.

In the alternative embodiment utilizing a second swing arm, the second swing arm conforms with the above description of the first swing arm, except that the second swing arm connects to the left and right wheel assemblies. In this embodiment the left and right wheels move vertically as one unit, and the front and rear wheels move vertically as one unit, with the rigid chassis acting as sprung weight.

In an alternative version of this embodiment, damping elements are added to work in tandem with the springs to prevent unwanted oscillations in the system.

In another alternative embodiment, the first swing arm or the second swing arm may use a four bar linkage to better control the wheel or caster assembly's angle while undergoing vertical travel. Other techniques known in the art of suspension design such as double wishbones, A-arms, short long arms (SLA), MacPherson struts, or Chapman struts may also be used.

In yet alternative embodiment, the vertical stalk is mounted to the first swing arm rather than the rigid chassis. This confers substantially the same benefits as the original embodiment. The choice of vertical stalk attachment point does impact the center-of-gravity in the fore-aft and left-right planes, and hence selection should be based on which plane benefits from the greatest stability when inclined.

FIG. 2 is a diagram illustrating the device traversing uneven terrain. The left-side driven wheel 203 has begun to traverse an obstacle 201. This imparts an upward and rotary movement to the left side of the rigid chassis 206 as shown by vector 213. This upwards movement also raises and rotates the stalk 210 and the audio-visual assembly 211. Gravity acts to keep the right-side driven wheel 204 in contact with the ground. The right side of the rigid chassis 207 is thus lower than the left side of the rigid chassis 206. The hinge mechanism 212 and spring 208 isolate the vertical movement of the rigid chassis from the swing arm assembly 209. This allows both the front caster wheel 205 and the rear caster wheel 201 to remain in contact with the ground.

The vertical movement of the driven wheels with respect to the caster wheels also allows the device to climb and descend ramps. Assuming the driven wheels are able to rise and fall +/−X above and below the caster wheels, and assuming the axis formed by the driven wheels is at the centerline of the distance Y, between the caster wheels, then the device can negotiate ramp angles of:

theta=180−arctan((Y/2)/X)*2

while maintaining ground contact with all four wheels.

Via this technique, the robot is able to traverse small obstacles and ramps while maintaining all four wheels in contract with the ground. At the same time, the device is stable and does not oscillate from side to side owing to the rigidity of the swing-arm.

FIG. 3 is an alternative embodiment illustrating the device with two swing-arms. A rigid chassis 301 supports a vertical stalk 302, which in-turn supports an audio-visual unit 303. In a typical embodiment, the vertical stalk is of a height that results in the audio-visual unit being at approximately human head height. In the preferred embodiment, the rigid chassis is made of stamped sheet metal, extruded tubes, or injection molded plastic, but other substantially rigid materials may also be used. Typically, the rigid chassis will be about thirty to sixty centimeters in length and width. In the preferred embodiment, the vertical stalk is composed of extruded aluminum or plastic tubing, but other substantially rigid materials may also be used. In the preferred embodiment the audio-visual unit is a plastic housing, but other materials may also be used.

The rigid chassis also serves as an attachment point for the first swing-arm 304 and the second swing-arm 305. In the present embodiment, the first swing-arm and second swing-arm attach the rigid chassis with hinges 306, but other means known in the art to establish a rotatable connection, such as rotating couplings, bearings, and rods may be used in lieu or in addition to the hinges. The first swing-arm is attached to the rigid chassis using two four bar linkages 311. The first swing-arm can thus travel in a predominantly vertical direction as constrained by the first compression spring 307, while maintaining a caster wheel orientation that is substantially orthogonal to the ground plane. The second swing-arm can travel is a predominantly vertical direction as constrained by the second compression spring 312, while maintaining a drive wheel orientation that is substantially orthogonal to the ground plane. The front and rear caster wheels 309 are rotatably attached to the first swing-arm. They travel as a unit when moving in the vertical direction relative to the rigid chassis. The left and right drive wheel assemblies 310 are attached to second swing-arm. They travel as a unit when moving in the vertical direction relative to the rigid chassis. Via this technique, the rigid chassis, vertical stalk, and audio-visual units act as unsprung weight, all four wheels make constant contact with the ground, and the device as a whole is resistant to rotational wobble about the left-right or fore-aft plane of the unit. This allows the device to traverse obstacles and climb ramps while remaining stable.

### ADVANTAGES

What has been described is a new and improved apparatus for implementing a differential drive system suspension on a robot with a high height to weight ratio.

By tying together the movement of both caster wheels and the movement of both differential drive wheels, the robot is able to maintain constant contact between the ground and all four wheels, without teetering. Because the fore-to-aft wheels and the left-to-right wheels are rigidly attached to separate support structures, the robot maintains a substantially constant vertical posture even in the presence of moderate lateral forces. Furthermore, the robot can traverse terrain that has surface irregularities without the drive wheels substantially losing contact with the surface. This allows the robot to more accurately follow a desired course. Finally, only one spring and one hinged assembly is required, simplifying the design of the suspension. The alternative embodiment with two swing-arms and two springs has improved obstacle traversal, better road-holding, and better stability relative to the one swing-arm design.

While certain exemplary embodiments have been described in detail and shown in the accompanying drawings, it is to be understood that such embodiments are merely illustrative of and not restrictive on the broad invention, and that this invention is not to be limited to the specific arrangements and constructions shown and described, since various other modifications may occur to those with ordinary skill in the art.

What is claimed:

1. A suspension for a differential drive robot consisting of:
a) a rigid chassis;
b) a swing-arm, rotatably connected to the rigid chassis;
c) at least two wheels connected to the rigid chassis; and
d) at least two wheels connected to the swing-arm;
e) wherein movement of the swing-arm keeps all four wheels in contact with the ground when traversing small obstacles and ramps.

2. The apparatus of claim 1, wherein:
the rigidity of the rigid chassis limits the robot's oscillations about a first axis, and the rigidity of the swing-arm limits the robot's oscillations about a second axis, the second axis substantially orthogonal to the first axis, and the first and second axes substantially parallel to the ground.

3. The apparatus of claim 1, further comprising:
a vertical support member, rigidly connected to the rigid chassis; and
a audio-visual assembly, rotatably connected to the vertical support member.

4. The apparatus of claim 1, wherein:
the two wheels connected to the swing-arm are driven by an electric motor; and
the two wheels connected to the rigid chassis are caster wheels.

5. A suspension for a differential drive robot consisting of:
a) a rigid chassis;
b) a first swing-arm, rotatably connected to the rigid chassis;
c) a second swing-arm, rotatably connected to the rigid chassis;
c) at least two wheels connected to the first swing-arm; and
d) at least two wheels connected to the second swing-arm;
e) wherein movement of the first swing-arm and second swing-arm keep all four wheels in contact with the ground when traversing small obstacles and ramps.

6. The apparatus of claim 5, wherein:
the rigidity of the first swing-arm limits the robot's oscillations about a first axis, and the rigidity of the second swing-arm limits the robot's oscillations about a second axis, the second axis substantially orthogonal to the first axis, and the first and second axes substantially parallel to the ground.

7. The apparatus of claim 5, wherein:
the two wheels connected to the first swing-arm are driven by an electric motor; and
the two wheels connected to the second swing-arm are caster wheels.
